(19) United States
(12) Patent Application Publication
(10) Pub. No.: US 2021/0232306 A1
(43) Pub. Date: Jul. 29, 2021

(54) A SWIPE TO CONNECT SYSTEM FOR PROVIDING TARGETED CONTENT TO A DEVICE

(71) Applicant: Handheld Community Ltd, Eastleigh, Hampshire (GB)

(72) Inventors: Brian HUGHES, Glasgow (GB); Stewart FRASER, Glasgow (GB)

(21) Appl. No.: 17/050,300

(22) PCT Filed: Apr. 23, 2019
(86) PCT No.: PCT/GB2019/000062

§ 371 Date: Oct. 23, 2020

Related U.S. Application Data
(63) Continuation of application No. PCT/GB2019/000037, filed on Mar. 1, 2019.
(60) Provisional application No. 62/661,971, filed on Apr. 24, 2018.

(51) Int. Cl. G06F 3/0488; G06F 3/0484; H04W 4/02; H04W 4/23; G06Q 30/02; H04L 29/06

(52) U.S. Cl. CPC G06F 3/04883; G06F 3/04845; H04W 4/02; G06F 3/03547; G06Q 30/0261; H04L 63/08; H04W 4/23

(57) ABSTRACT

A computer implemented system for providing content to a device based upon the location of the device. A captive portal is provided via a vendor network for display on a device screen. Distinct first and second gestures are used to navigate access, they may include, swipes, to the left, to the right, upwards, downwards, arcuate or circular clockwise or arcuate or circular anticlockwise gestures. The first user gesture on the screen provides the device with access to additional information relevant to the content page, and a second user gesture on the screen causes the access management system to remove content page from the screen, such that after step (i), the device is provided with internet access via the vendor network or is shown n additional content pages displayed sequentially and after step (ii) the device is provided with internet access via the vendor network or is shown n additional content pages then is provided with internet access via the vendor network.

### INTRODUCTION

The present invention relates to a system and method for providing internet access to a computing device (device) such as, but not limited to a mobile phone, tablet computer or lap top computer. The invention also provides location targeted content to the device in an open and transparent manner. The targeted information may be information which is relevant to the location such as advertising including hyper local advertising, visitor information or the like.

### BACKGROUND TO THE INVENTION

Computing device use has become an integral part of modern life. The device allows us to communicate with others verbally, by text, by social media, make purchases and so on. It is also a source of information for social media providers, advertisers and the like. The information may relate to the location of the computing device and/or the information provided by the user of the device.

Wireless connection to the internet may be via a home or office wireless local area network, a public network or another network, described herein as a vendor network. Such networks typically use Wi-Fi® a wireless system based on IEEE Standard 802.11. A vendor network is any network where the operator of the network is prepared to provide access to the internet to a device, usually as part of a commercial transaction. The commercial transaction could be a user and device entering and/or using the vendor premises to use its services such as a shop, shopping mall, hotel, restaurant, café or other public venue such as a bar, museum, sports facility and so on. The most common authentication methods used for public access Wi-Fi are open access (no password), pre-shared key (password) or captive portal (a.k.a. “Splash Page”). Captive portal is a web-based authentication method that requires users to take specific actions before being granted access to a wireless network and the Internet. A captive portal facilitates direct audience engagement at a critical point during a user's Internet experience, and is therefore a powerful medium that can be used for a flexible range of use cases including advertising, promoting brand awareness, surveys, polls etc. Captive portals can be found built into many wireless equipment manufacturer's controllers but many also allow for externally hosted custom captive portals to be configured.

In many cases, the initial stage of providing internet access on a vendor network is via a Captive Portal Assistant (CPA) or wireless network popup/overlay, such as Apple's Captive Network Assistant. The CPA is a limited function browser that opens on most devices when they attempt to connect to a service set identifier (SSID) and sends the device to a captive portal environment. The purpose of the CPA is to help users navigate the captive portal process. If the captive network assistant or CPA is not present the user would have to open a browser and trigger the captive portal manually by making a non-HTTPS-based request. Additional Operating Systems such as Windows also support captive portal networks by immediately opening the web browser if a captive portal is detected.

A client that has not clicked-through, swiped-through or signed-on to the Splash Page is “unauthenticated”. Generally, network access is restricted to the Captive Portal Strength and Walled Garden configuration on the SSID for unauthenticated clients, which are defined as follows:

Captive Portal Strength: Defines the scope of network access a client has prior to authentication (e.g. Allow non-HTTP traffic prior to authentication or block all access until authentication is complete).

Walled Garden: Specifies which IP addresses, IP ranges, or hosts an unauthenticated client can access regardless of Captive Portal Strength.

Clients who have not authenticated are unable to access network resources outside of the Captive Portal with the exception of IP address, ranges or hosts specified in the Walled Garden (a list of network resources clients are allowed access to prior to authentication). When authentication expires or the client has their access revoked they will be placed back into the Captive Portal and authentication will be required to regain full network access.

At present, there are two main approaches to authentication:
Click-Through Splash′, where the user is redirected to a captive portal and clicks on a link (e.g. accepts terms, clicks ad to visit online shop) to be granted access to the Internet. Provides a limited opportunity for the vendor network operator (VNO) to communicate and/or engage with device users before connecting them to the internet.
Sign-on Splash, where the user is redirected to a splash page and must either sign up or enter predefined user credentials to be granted access after validation against a user database (e.g. username, date of birth, postcode etc.) or social sign on. There are several variations of Sign-on splash including:
   Password. In this case, the VNO provides access to their vendor network by providing a password for a fee or as a courtesy to customers. This provides minimal display and direct response advertising and other user engagement opportunity (e.g. polls, ratings, surveys) limiting value to the VNO.
   Mandatory data capture requires a new user to give information such as an email address, date of birth and other personal information which can be used by the VNO for marketing purposes. Entering this data can be cumbersome and time consuming for the device user and can be viewed as intrusive resulting in high drop-out rates and poor data quality. Data protection regulations such as the EU General Data Protection Regulation (GDPR) severely restrict the efficacy of this method as explicit opt-in consent is required by the user. As with the previous approach offers minimal display and direct response advertising and user engagement opportunity limiting value to the VNO.
   Social media login enables VNOs to capture data from users social media profiles for marketing purposes. Suffers in much the same way as previous methods.
   Room number/surname or authentication code authentication is also commonly used by hotels. Again, offers limited value to the VNO other than restricting use of the Wi-Fi network to hotel guests/event attendees.

From the existing authentication methods listed above, Click-Through Splash offers the best opportunity for VNOs to create value by presenting display or direct response advertisements and other engagement opportunities to the user as they navigate from the landing page/captive portal to the internet.

Much of this advertisement is location-based and is based on the premise that users' locations and their proximity to a place of interest impact the performance of an advertising campaign. Location-based advertising has developed to enable advertisers to analyse campaign performance by individual places of interest across millions of locations to understand precisely where within a location, consumers are active and what they are doing.

It is also notable that device users expect ubiquitous connectivity, that is, the ability to enter a vendor premises and gain access to the internet via a vendor network.

However, device users are resistant to delay in connection and to overly aggressive and intrusive advertisements which have a negative impact on the user experience of the venue. At the same time, vendors wish to be able to present a call to action which provides them with the opportunity to promote their goods and services to the device user.

### SUMMARY OF THE INVENTION

An object of the present invention is to facilitate the deferment of authentication onto a wireless network until after a series of interactions are completed.

Another object of the present invention is to provide location targeted and/or personalised content to a captive portal in order to maximise the opportunity to engage/interact with users connecting to a wireless network.

Another object of the invention is to provide a vendor agnostic extension to the ‘Click-Through Splash’ that allows for multiple click-through authentication opportunities to be presented and for the deferment of authentication until after a series of interactions are completed (‘Swipe-Through Splash’). It can also be combined with Sign-on Splash methods to provide engagement/interaction and marketing opportunities to users that currently don't exist. This combined with provision of location targeted and/or personalised content to the captive portal maximises the opportunity to engage with users connecting to the wireless network.

It is another object of the present invention to provide businesses and other organisations in a locality such as tourist information centres and museums with a platform through which they may provide web-based content to users.

It is another object of the present invention to provide a network system and a computer implemented method for providing content to a computing device connecting to a vendor network.

In accordance with the first aspect of the invention there is provided a computer implemented content management system for providing content to a device based upon the location of the device:

wherein the content management system stores a VNO profile, campaigns and content cards which are displayable on a screen of a device within a captive portal;

such that, upon receiving a connection request from the device via a vendor network, a captive portal is displayed on the device populated with content from the content management system wherein;
(i) A user:
   a. gestures to progress beyond a default card from the screen, or
   b. submits data progress beyond the default card (pre-authentication)
(ii) the device is authenticated onto the vendor network and then redirected to a campaign completion URL network if no additional content available, if additional content is available, the device is shown n additional content cards displayed sequentially upon detection of a second and subsequent gesture until,
(iii) User:
   a. gestures on a call to action link in a content card in the campaign, wherein device is authenticated onto vendor network and then redirected to call to action destination URL, or
   b. gestures to progress through the remaining content cards, after which, device is authenticated onto vendor network and then redirected to the campaign completion URL.

In accordance with a second aspect of the invention there is provided a computer implemented graphical control element for a device, the control element comprising a captive portal for a device, being adapted to display the captive portal which is presented to the device from a content management system via a vendor network, wherein, the captive portal displays at least one content card on the screen of the device wherein:
(i) A user:
   a. gestures to progress beyond a default card from the screen, or
   b. submits data progress beyond the default card (pre-authentication)
(ii) the device is authenticated onto the vendor network and then redirected to a campaign completion URL network if no additional content available, if additional content is available, the device is shown n additional content cards displayed sequentially upon detection of a second and subsequent gesture until,
(iii) User:
   a. gestures on a call to action link in a content card in the campaign, wherein device is authenticated onto vendor network and then redirected to call to action destination URL, or
   b. gestures to progress through the remaining content cards, after which, device is authenticated onto vendor network and then redirected to the campaign completion URL.

In accordance with a third aspect of the invention there is provided a computer so implemented content management system for providing content to a device based upon the location of the device:

wherein the content management system stores a vendor profile and zero or more content cards contained in a captive portal and which are displayable on a screen of the device;

such that, upon receiving a connection request from the device via a vendor network, the captive portal is provided to the device from the content management system via a vendor network, the captive portal displaying the content to the device wherein;
(i) A user:
   a. gestures to progress beyond a default card from the screen, or
   b. submits data progress beyond the default card (pre-authentication)
(ii) the device is authenticated onto the vendor network and then redirected to a campaign completion URL network if no additional content available, if additional content is available, the device is shown n additional content cards displayed sequentially upon detection of a second and subsequent gesture until,
(iii) User:
   a. gestures on a call to action link in a content card in the campaign, wherein device is authenticated onto vendor network and then redirected to call to action destination URL, or
   b. gestures to progress through the remaining content cards, after which, device is authenticated onto vendor network and then redirected to the campaign completion URL.

Preferably, the content management system is a cloud hosted web application.

Preferably, one default card is present in a campaign.

Preferably, at least one content card is present in a campaign but not required.

Preferably, the n additional content cards in a campaign are displayed sequentially where n=>0.

Preferably, the vendor network comprises one or more wireless access points.

Preferably, the vendor network includes a wireless controller.

Preferably, the wireless controller is a cloud-based software application.

Preferably, a content management system is provided to allow the vendor to manage the content.

Preferably, the content management system comprises a graphical user interface.

Preferably the content management system also provides an API (Application Programming Interface)

Preferably, the interface allows vendor defined content to be uploaded to the content management system.

Preferably, the content management system can allow content to be mapped to one or more specified wireless access points.

Preferably, the content management system can allow content to be mapped to one or more specified wireless access points based upon different criteria including time, date and location.

Preferably, the content management system comprises at least one of the following features: user login, registration and management, content card and campaign management, access point management, billing and analytics dashboard.

Preferably, the MAC address of the wireless access point is used to determine its location.

Optionally, the network ID or location ID is used to determine location.

Preferably, where there is a plurality of wireless access points, they may be grouped for the purpose of receiving selectively uploaded vendor defined content.

Optionally, they are grouped by their proximity to one another.

Optionally, they are grouped by their proximity to goods or services.

Preferably, the content management system can be configured to determine the order in which the content cards are presented to the device.

Preferably, the content management system determines the content cards to be shown to the device based upon the device's location.

Preferably, the graphical user interface has a touch screen.

Preferably, the first user gesture comprises of a swipe.

Optionally, the first user gesture comprises a click or pointing action on the graphical user interface of the device.

Typically, the first user gesture comprising of a click will submit data entered by the user to confirm progress beyond the default card is allowed.

Typically, the data entered by the user to confirm progress allowed beyond the default card is hotel room number and surname, access code or mobile phone number/SMS verification code.

Typically, when a mobile phone number is entered to confirm progress is allowed beyond the default card, a verification code is sent via SMS to user's device.

Typically, the click will be made using a hand held pointing device such as a computer mouse or track pad.

The pointing action will be a short pointing press against the graphical user made by a user's finger a stylus, pointer or the like.

Preferably, the second user gesture comprises moving a DOM element on the screen

More preferably, the second user gesture comprises a swipe on the graphical user interface of the device. The swipe comprises a prolonged movement across the graphical user interface.

Typically, the prolonged movement may be made using a hand held pointing device such as a computer mouse or track pad.

Typically, the prolonged movement may be made by a user's finger, a stylus, pointer or the like.

Preferably, the captive portal is displayed if the device is not authenticated when connecting to a vendor network.

Preferably, the content comprises a default card. Custom branding/messaging can be applied to this card as required.

Preferably the device is any suitable computing device including but not limited to a mobile phone, smart phone, tablet computer or laptop computer.

Preferably the system further comprises an tool that acquires and analyses data on the effectiveness of the campaigns and content cards.

Preferably or alternatively, in any aspect of the present invention, upon receiving a connection request from the device via a vendor network, the captive portal is provided to the device from the access management system via a vendor network, the captive portal displaying the content page to the device wherein;

(i) upon detection of a first user gesture by the screen, the access management system provides the device with access to additional information relevant to the content page, or

(ii) upon detection of a second user gesture by the screen, the access
management system removes content page from the screen, such that after step (i), the device is provided with internet access via the vendor network or is shown n additional content pages displayed sequentially and after step (ii) the device is provided with internet access via the vendor network or is shown n additional content pages then is provided with internet access via the vendor network.

Preferably, the screen is able to distinguish between the first gesture and the second gesture to enable either operation (i) or operation (ii).

Preferably, the first user gesture comprises connecting to a hyperlink which navigates them to a URL.

More preferably, the first user gesture comprises a click or pointing action on the graphical user interface of the device.

Optionally, the detection of the first gesture or the second gesture comprises detecting the movement of a user's finger, stylus pointer or the like across the graphical user interface.

Optionally, the detection of the first gesture or the second gesture comprises detecting movement across the graphical user interface in one of the following motions, to the left, to the right, upwards, downwards, arcuate or circular clockwise or arcuate or circular anticlockwise.

Optionally, the detection of the first gesture occurs in a first space on the graphical user interface defined by a first arc subtended by a predetermined angle as defined with reference to a reference line across the graphical user interface and the detection of the second gesture occurs in a second space on the graphical user interface defined by a second arc subtended by a predetermined angle as defined with reference to the reference line such that the first space and the second space are on opposing sides of the reference line.

Optionally, the predetermined angle is between 0 and 180° with respect the reference line.

Optionally, the predetermined angle is between 15 and 165° with respect the reference line.

Optionally, the predetermined angle is between 30 and 150° with respect the reference line.

Optionally, the predetermined angle is between 45 and 135° with respect the reference line.

Optionally, the predetermined angle is between 0 and −180° with respect the reference line.

Optionally, the predetermined angle is between −15 and −165° with respect the reference line.

Optionally, the predetermined angle is between −30 and −150° with respect the reference line.

Optionally, the predetermined angle is between −45 and −135° with respect the reference line.

Preferably, a first gesture made out-with first space will not cause the access management system to provide the device with access to additional information relevant to the content page.

Preferably, a second gesture made out-with the second space will not cause, the access management system to remove a content page from the screen,

Preferably, the access management system is a cloud hosted web application.

Preferably, at least one content page is vendor defined.

Preferably, the n additional content pages are displayed sequentially.

Preferably, the vendor network comprises one or more wireless internet access points and a wi-fi controller.

Preferably, the wi-fi controller is a cloud-based software application.

Preferably, the vendor defined content comprises a splash page.

Preferably, the access management application comprises a vendor interface.

Preferably, the vendor interface allows vendor defined content to be uploaded to the access management application.

Preferably, the access management system can selectively upload vendor defined content to one or more specified wireless internet access point.

Preferably, the access management system can selectively upload vendor defined content to one or more specified wireless internet access point based upon the vendor defined criteria.

Preferably, a content management system is provided to allow the vendor to manage the content.

Preferably, the content management system comprises at least one of the following features Customer login, registration and management, cards, campaign, access point, user management and analytics dashboard.

Preferably, the MAC address of the wireless Internet access point is used to determine its location.

Optionally, the network ID is used to determine location.

Optionally, the vendor defined criteria is location.

Optionally, the vendor defined criteria is a desire to advertise goods or services.

Preferably, where there is a plurality of wireless internet access point. They may be grouped for the purpose of receiving selectively uploaded vendor defined content.

Optionally, they are grouped by their proximity to one another.

Optionally, they are grouped by their proximity to goods or services.

Preferably, the access management system can be configured to determine the order in which the vendor defined content is presented to the mobile device.

Preferably, the access management system determines the vendor defined content to be shown to the mobile device based upon the device's location.

Preferably, the graphical user interface has a touch screen.

Typically, the click will be made using a hand-held pointing device such as a computer mouse or track pad.

The pointing action will be a short pointing press against the graphical user made by a user's finger a stylus, pointer or the like.

Preferably, the second user gesture comprises moving a DOM element on the screen

More preferably, the second user gesture comprises a swipe on the graphical user interface of the mobile device. The swipe comprises a prolonged movement across the graphical user interface.

Typically, the prolonged movement may be made using a hand held pointing device such as a computer mouse or track pad.

Typically, the prolonged movement may be made by a user's finger, a stylus, pointer or the like.

Preferably, the captive portal is displayed if the mobile device is not authenticated in the vendor network.

Preferably, n=1 and two content pages are shown in total.

Optionally, n=2 and three content pages are shown in total.

Preferably, the content comprises a first page which is a default page which is presented to unauthenticated devices connecting to the wireless network. Custom branding/messaging can be applied to this card as required.

2. Content card(s)—Campaigns can contain one or more content cards. Content cards are created and assigned to campaigns in the CMS. The content displayed in cards is dictated to by the card type. Card types include simple image, image with call to action button (e.g. visit shop) and blog but extensibility of system allows for the development of additional card types supporting more complex interactions (e.g. facebook likes, trip advisor ratings, newsletter signup and other third-party API integrations). Cards dynamically displaying localised content based on device location or personalised content based on previous interactions with the system is also possible.

Preferably, the access management system is a cloud-based software application.

Preferably, the wi-fi controller is a cloud-based software application.

Preferably the mobile device is any suitable mobile device including but not limited to a mobile phone, smart phone, portable media player, tablet computer or laptop computer.

Preferably the system further comprises an analysis tool which acquires and analyses information on the effectiveness of the campaign.

Preferably, the information pertains to one or more user or group of users.

### BRIEF DESCRIPTION OF THE DRAWINGS

The present invention will now be described with reference to the accompanying drawings in which:

FIG. 1 is a flow diagram which shows the steps taken by a vendor in an example of a system in accordance with the present invention;

FIG. 2 is a flow diagram which shows the steps taken by a user on a device connecting to a vendor network in an example of a system in accordance with the present invention;

FIG. 3 illustrates a campaign created by a vendor using the system of the present invention.

FIG. 4a is a schematic diagram which illustrates a first example of a swipe to connect process in accordance with the present invention and FIG. 4b is a schematic diagram which illustrates a second example of a swipe to connect process in accordance with the present invention, FIG. 4c is a schematic diagram which illustrates a third example of a swipe to connect process in accordance with the present invention and FIG. 4d is a schematic diagram which illustrates a fourth example of a swipe to connect process in accordance with the present invention;

FIG. 5a is a sequence diagram which shows an example of the interactions required to connect to a wireless network, FIG. 5b is a sequence diagram which shows an example of the interactions required to connect to a wireless network using HTTP POSTs, FIG. 5c is a sequence diagram which shows an example of the interactions required to connect to a wireless network managed by a wireless network controller using HTTP GETs, FIG. 5d is a sequence diagram which shows an example of the interactions required to connect to a wireless network managed by a wireless network controller using HTTP POSTs, FIG. 5e is a sequence diagram which shows an example of the interactions required to connect to a wireless network managed by a wireless network controller using HTTP GETs and RADIUS authentication, FIG. 5f is a sequence diagram which shows an example of the interactions required to connect to a wireless network managed by a wireless network controller using HTTP POSTs and RADIUS authentication and FIG. 5g is a sequence diagram which shows an example of the interactions required to connect to a wireless network managed by a wireless network controller using API requests;

FIG. 6 is a graph which compares connection completions using the present invention with those for a known technology;

FIG. 7 is a schematic diagram which illustrates a third example of a swipe to connect process in accordance with the present invention;

FIG. 8 is a schematic diagram which illustrates a fourth example of a swipe to connect process in accordance with the present invention;

FIG. 9 is a schematic diagram which illustrates a fifth example of a swipe to connect process in accordance with the present invention;

FIG. 10 is a schematic diagram which illustrates a sixth example of a swipe to connect process in accordance with the present invention;

FIG. 11 is a schematic diagram which illustrates a seventh example of a swipe to connect process in accordance with the present invention;

FIG. 12 is a schematic diagram which illustrates a eighth example of a swipe to connect process in accordance with the present invention; and

FIG. 13 is a schematic diagram which illustrates a ninth example of a swipe to connect process in accordance with the present invention.

### DETAILED DESCRIPTION OF THE DRAWINGS

The present invention is a computer implemented hardware and software solution, which has been designed to provide a platform through which a range of content created by members of a network can be offered to users.

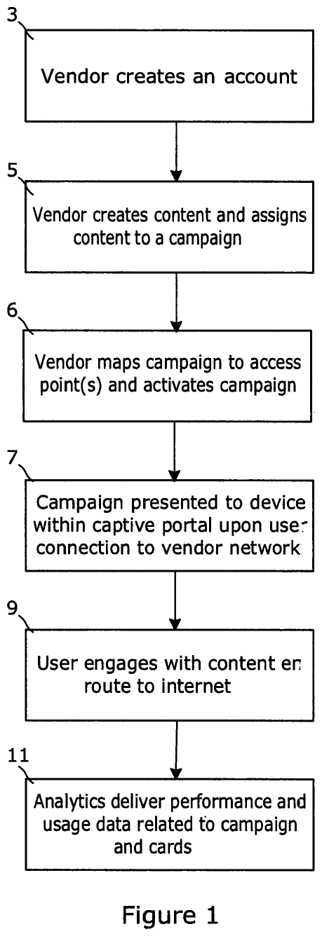

FIG. 1 is a flow diagram 1 which shows the steps taken by the vendor in an example of a system in accordance with the present invention. In this example of the present invention, the vendor is a venue such as a café or bar. A vendor account is created 3 on the content management system, content is created and assigned to a campaign and the campaign is mapped to access points and activated 6. Upon a user device connecting to the vendor network the campaign is presented to the device 7. The campaign comprises a series of cards which are delivered via a captive portal to a user device.

The content management system has an interface which allows content to be uploaded to it. In addition, the content may be selectively made available to wireless access points based upon the vendor defined criteria such as location or a desire to advertise goods or services at a location. The order in which the content is presented is also controlled via the content management system.

The campaign 5 is presented to the device from the content management system via the vendor network which is located so as to provide Internet access to devices in the vendor premises. Thereafter the customer engages with the content in the captive portal en-route to obtaining Internet access via the vendor network in the vendor premises.

Information on the extent to which the device interacted with the content is provided to the system of the present invention and fed into an analytical tool 11. The purpose of the tool is to acquire and analyse information on the effectiveness of the campaign and cards in general and in relation to one or more users or group of users based on various factors, including but not limited to, location, date and time.

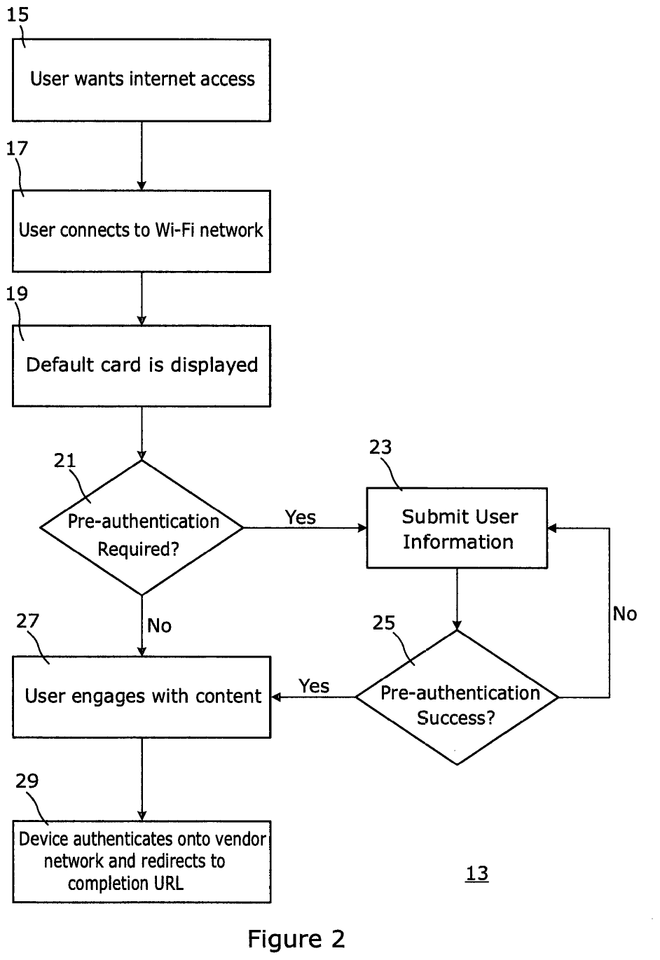

FIG. 2 is a flow diagram which shows the steps taken by the device when seeking to obtain Internet access via the vendor network.

In the flow diagram 13 the first step is that the device of the customer seeks access the Internet via the vendor network 15. The device then connects to the vendor network 17 and the campaign and its content from the content management system is displayed upon the graphical user interface of the device 19.

The first card displayed to the user upon connection to the vendor network is the default card 19. Based upon the campaign the settings, pre-authentication can be enabled and required before a user can engage with the content. Typically, when pre-authentication is enabled 21, the data entered by the user to proceed beyond pre-authentication is hotel room number and surname, access code or mobile phone number/SMS verification code 23. If the user provided information does not pass pre-authentication checks then they are asked to re-enter the information again. Once a user has successfully completed pre-authentication 25 then can continue beyond the default card 27 and engage with the content 29.

The content is typically information which the vendor or the content management system wishes to draw to the attention of the device user. This will often include a call to action such as an offer of service, an offer of goods, information on other services which may be of interest to the device user and so on. The content card will also allow the user to interact with the card and to go beyond the content which is displayed to obtain additional information on the offer. This is achieved using a gesture which may be clicking upon a button in the content card displayed on the graphical user interface of the device.

This step is shown at box 21 of FIG. 2 illustrates the point in the process where the user has completed their interaction with content card and has viewed the associated content, in this example of the present invention the user device is then authenticated and granted free access to the Internet via the vendor network 23 and redirected to the content card completion URL.

In another example of the present invention, after the campaign and content has been viewed, the device is authenticated on to the vendor network and redirected to the campaign page on the content management system or other completion URL so that the device can engage with additional content.

In situations where the user device reaches the captive portal by connecting to the vendor Wi-Fi 17, if the user of the device does not wish to engage further with the content, the user may use a second gesture upon the graphical user interface of the device in order to move past the content.

In a preferred embodiment of the invention, the gesture to proceed through the content cards is a swiping motion of the user's finger from right to left across the graphical user interface of the device. Whilst viewing a content card, a subsequent gesture can be made in the form of a click whereby the users device will be authenticated and redirected to a URL and content displayed upon the graphical user interface of the device. In the preferred embodiment of the present invention a campaign contains a default card and n>=0 number of content cards shown in sequence after which the user device is granted Internet access via the vendor network.

Advantageously the present invention provides a clear and simple system for providing Internet access via a vendor network which is quick and simple to use. It provides an enhanced user experience and a means for allowing a vendor to present their goods services and information in a simple and transparent manner in exchange for providing internet access to a user.

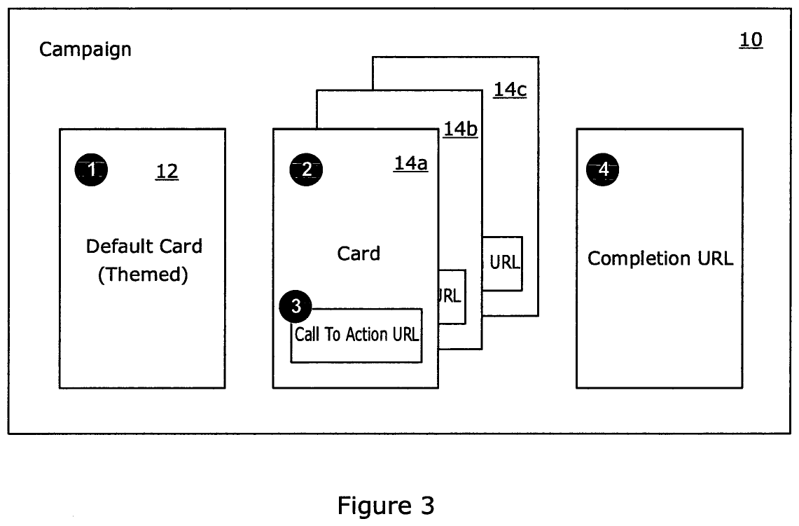

FIG. 3 illustrates a campaign 10 created by a vendor using the system of the present invention.

1. Default Card 12—The first card presented to unauthenticated devices connecting to the wireless network. Custom branding/messaging can be applied to this card as required, as well as pre-authentication requirements whereby a user must supply additional information to proceed beyond the default card and on to the content cards.

2. Content card(s) 14a, 14b and 14c—Campaigns can contain zero or more content cards. Content cards are created and assigned to campaigns in the content management system. The content displayed in cards is dictated to by the card type. Card types include simple image, image with call to action button (e.g. visit shop) and blog but extensibility of system allows for the development of additional card types supporting more complex interactions (e.g. facebook likes, trip advisor ratings, newsletter signup and other third-party API integrations). Cards dynamically displaying localised content based on device location or personalised content based on previous interactions with the system is also possible.

3. Call to Action URL—Irrespective of type, cards with a call to action URL (grant URL+continue_url) behave like traditional Click-Through splash pages, authenticating the client device onto the wireless network and redirecting to the call to action URL when clicked.

4. Completion URL 16—URL client device will redirect to on swipe of last card in campaign.

In the following embodiments, the terms upwards and downwards, right left and other such terms relate to gestures as shown on a screen or graphical user interface. A skilled person would understand that these terms are used relative to the content as it would be normally viewed and are not fixed with respect to the screen aspect ratio or, for example a portrait or landscape view of its content.

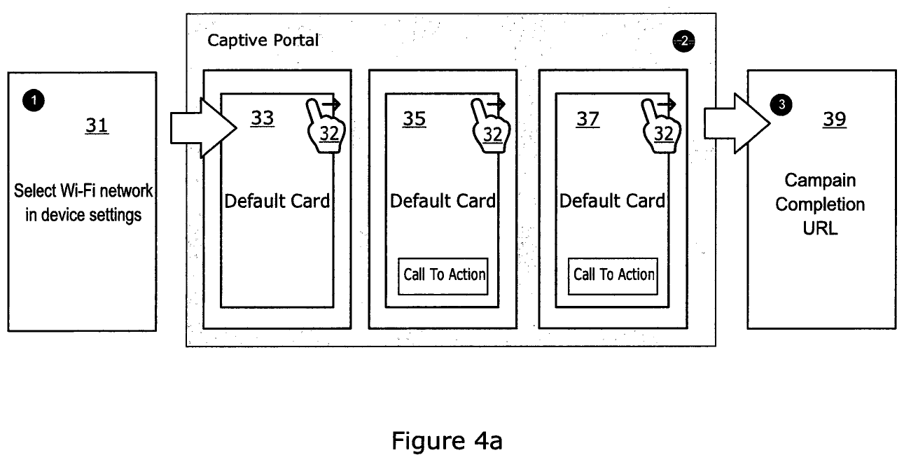

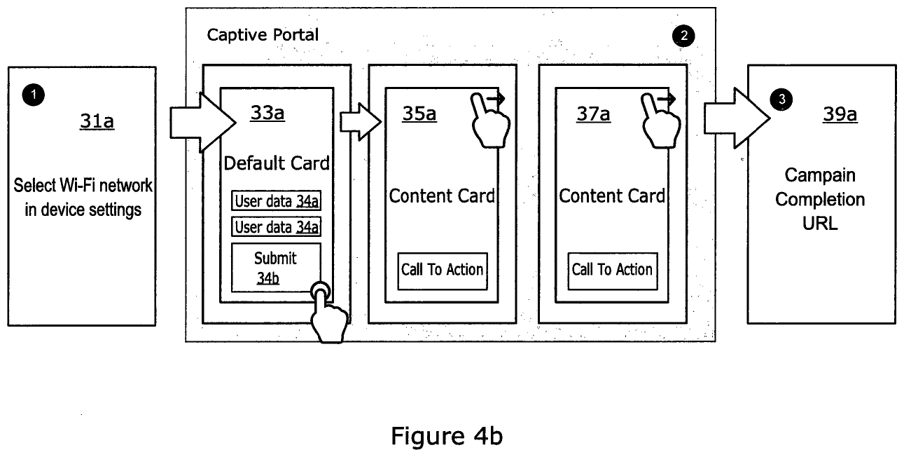

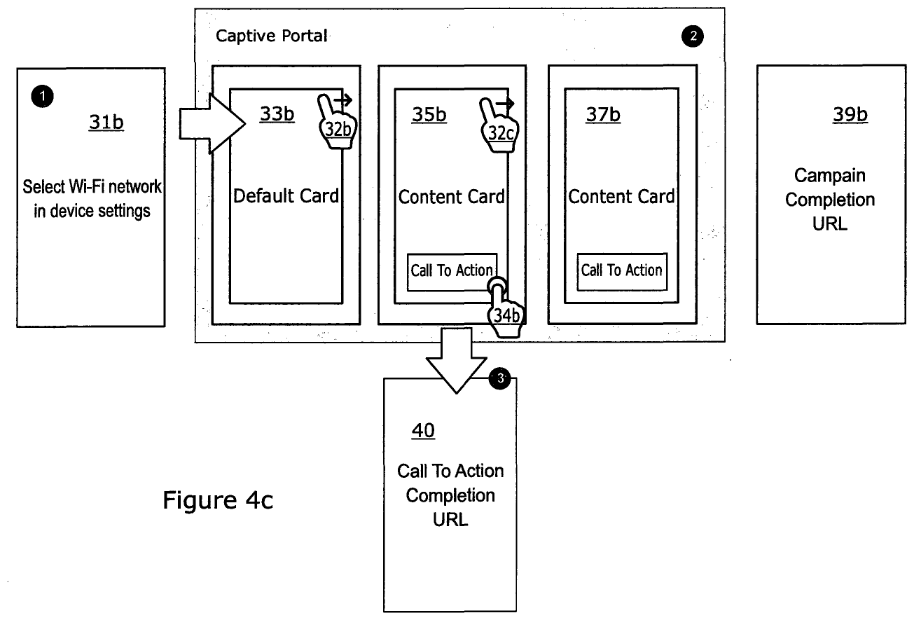

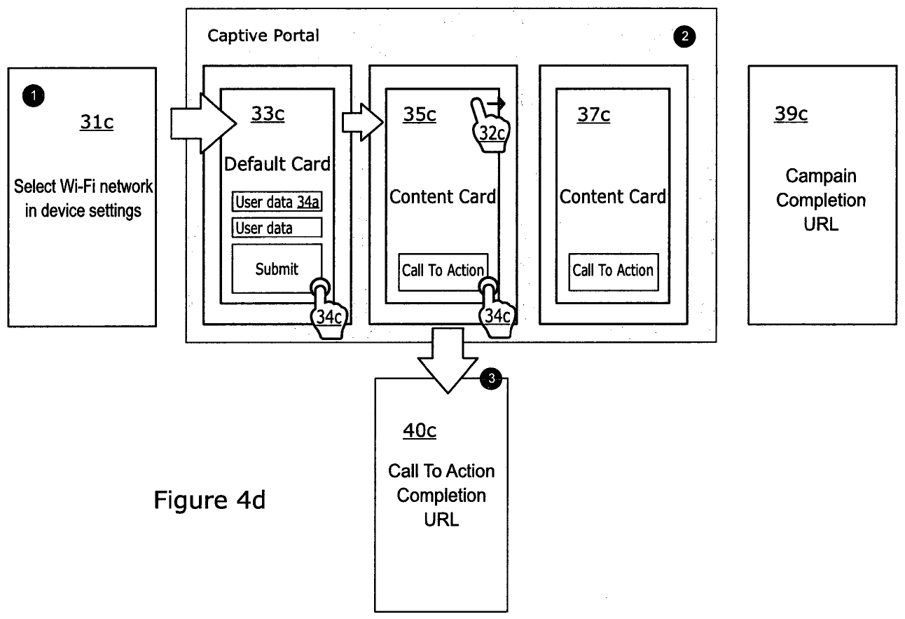

FIG. 4a is a schematic diagram which illustrates a swipe to connect process in accordance with the present invention. FIG. 4 25 shows a user device 27 screen at five different steps which takes the device through the process of obtaining full Internet access via a vendor network.

At the first step 31, the user accesses the settings on the device, identifies and requests connection with the vendor network. Once connection has been established the device 27 receives upon its graphical user interface content 33, the default card. After viewing the required default card, the user can swipe 32 beyond the default card using a second gesture which is as described above in this embodiment of the invention is a swipe across the screen.

In this example of the present invention where the user has swiped 32 through the content of the default card 33, the user is presented with the first content card 35. Similarly, the user may swipe 32 through this content or access the content as described above. Where the user has chosen to swipe through, a second content card 37 is presented on the device graphical user interface. In this example of the present invention after the second content card has been presented on the device graphical user interface, the system allows the user device full Internet access 39. In this example, the user swipes through all of the cards to reach the end of the campaign at which point the device is authenticated onto wireless network and redirected to destination URL for the campaign.

In summary

1. User connects to wireless network by selecting network's SSID on their device.

2. User swipes through the default card

3. User swipes to the end of the campaign in the captive portal where there may be zero or more content cards within a campaign).

4. Device is authenticated onto wireless network and redirected to completion URL for the campaign.

FIG. 4b is a schematic diagram which illustrates a swipe to connect process in accordance with the present invention. FIG. 4 25 shows a user device 27 screen at five different steps which takes the device through the process of obtaining full Internet access via a vendor network.

At the first step 31a, the user accesses the settings on the device, identifies and requests connection with the vendor network. Once connection has been established the device 27 receives upon its graphical and user interface content 33a, the default card. In this example, the default card includes required pre-authentication where additional user supplied information is required to continue beyond the default card. After supplying additional information on the default card, the user performs a finger click 34a within an active area on the graphical user interface to submit 34b and validate the user supplied information. If the pre-authentication checks fail the user will be asked to input the required information again. If pre-authentication succeeds, the user is automatically progressed to the first content card 35a.

Where the user has passed pre-authentication, they are automatically progressed beyond default card 33a and the user is presented with the first content card 35a. Similarly, the user may swipe 32a through this content or access the content as described above. Where the user has chosen to swipe through, a second content card 37 is presented on the device graphical user interface. In this example of the present invention after the second content card has been presented on the device graphical user interface, the system allows the user to swipe 32a through last content card 37a and the user device is granted full Internet access on the vendor network. In this example, the user swipes through all of the content cards to reach the end of the campaign at which point the device is authenticated onto wireless network and redirected to the completion URL for the campaign 39a.

In summary
1. User connects to wireless network by selecting network's SSID on their device.
2. User inputs required information for pre-authentication validation, and if successful, is automatically moved to the first content card.
3. User swipes to the end of the campaign in the captive portal (where there may be zero or more content cards within a campaign).
4. Device is authenticated onto wireless network and redirected to completion URL for the campaign.

FIG. 4c is a schematic diagram which illustrates a swipe to connect process in accordance with the present invention. This differs from FIG. 4a in that the user clicks on a call to action/link button during the campaign. FIG. 4c shows a user device 27 screen at six different steps which takes the device through the process of obtaining full Internet access via a vendor network.

At the first step 31b, the user accesses the settings on the device, identifies and requests connection with the vendor network. Once connection has been established the device 27 receives upon its graphical and user interface content 33b, the default card. After viewing the required default card, the user can swipe 32b beyond the default card using a gesture which is as described above in this embodiment of the invention is a swipe across the screen from right to left.

Once the user has swiped 32b, the first content card 35b is shown. In this case, the user has decided that the content is of interest and uses a gesture such as a finger click 34b within an active area on the graphical user interface to access additional information on the contents of page 40. After performing the click 34b the device is authenticated onto wireless network and redirected to card's call to action completion URL.

The user may swipe 32b through this content or access the content as described above. Where the user has chosen to swipe through, a second content card 37b is presented on the device graphical user interface. In this example of the present invention after the second content card has been presented on the device graphical user interface, the system allows the user device full Internet access 39b. Upon reaching the end of the campaign the device is authenticated onto wireless network and redirected to the completion URL for the campaign.

In summary,
1. User connects to wireless network by selecting network's SSID on their device.
2. User swipes through the default card
3. User clicks on a call to action link in any content card in the campaign (where there may be zero or more content cards within a campaign).
4. Device is authenticated onto wireless network and either:
   a. redirected to card's call to action completion URL, or
   b. redirected to the campaign completion URL if there are no content cards in the campaign

FIG. 4d is a schematic diagram which illustrates a swipe to connect process in accordance with the present invention. This differs from FIG. 4b in that the user clicks on a call to action/link button during the campaign. FIG. 4d shows a user device 27 screen at six different steps which takes the device through the process of obtaining full Internet access via a vendor network.

At the first step 31c, the user accesses the settings on the device, identifies and requests connection with the vendor network. Once connection has been established the device 27 receives upon its graphical and user interface content 33c, the default card. In this example, the default card includes required pre-authentication where additional user supplied information is required to continue beyond the default card. After supplying additional information 34a on the default card, the user performs a finger click 34c within an active area on the graphical user interface to submit and validate the user supplied information. If the pre-authentication checks fail the user will be asked to input the required information again. If pre-authentication succeeds, the user is automatically progressed to the second content card 35c.

Where the user has passed pre-authentication, they are automatically progressed beyond default card 33c and the user is presented with the first content card 35c. In this case, the user has decided that content card 35 is of interest and uses a gesture such as a finger click 34c within an active area on the graphical user interface to access additional information on the contents of page 40. After performing the click 34c the device is authenticated onto wireless network and redirected to card's call to action completion URL.

The user may swipe 32c through this content or access the content as described above. Where the user has chosen to swipe through, a second content card 37c is presented on the device graphical user interface. In this example of the present invention after the second content card has been presented on the device graphical user interface, the system allows the user device full Internet access 39. Upon reaching the end of the campaign the device is authenticated onto wireless network and redirected to the completion URL for the campaign.

In summary,
1. User connects to wireless network by selecting network's SSID on their device.
2. User inputs required information for pre-authentication validation, and if successful, is automatically moved to the first content card.
3. User clicks on a call to action link in any content card in the campaign (where there may be zero or more content cards within a campaign).
4. Device is authenticated onto wireless network and either:
   a. redirected to card's call to action completion URL, or
   b. redirected to the campaign completion URL if there are no content cards in the campaign

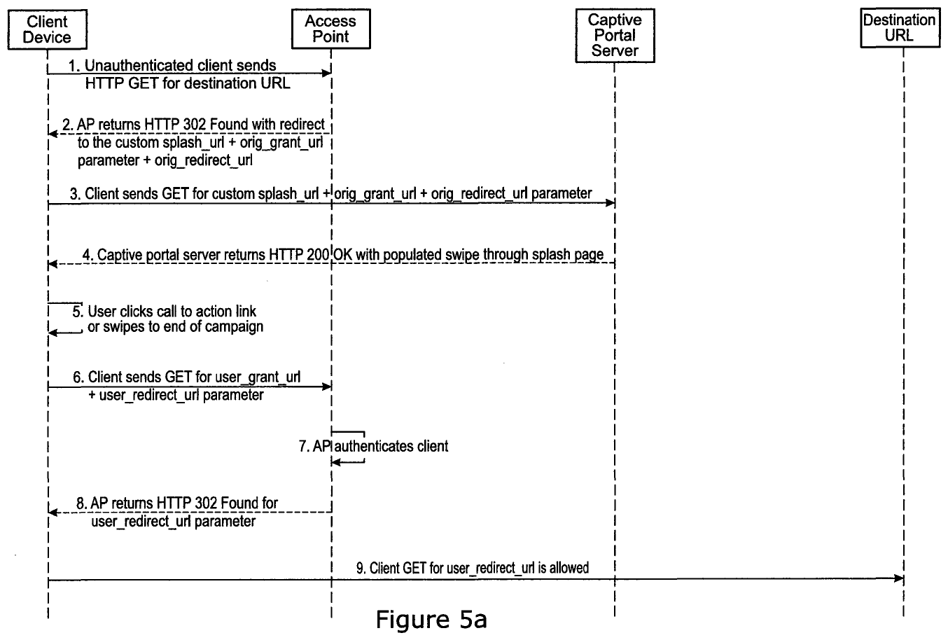

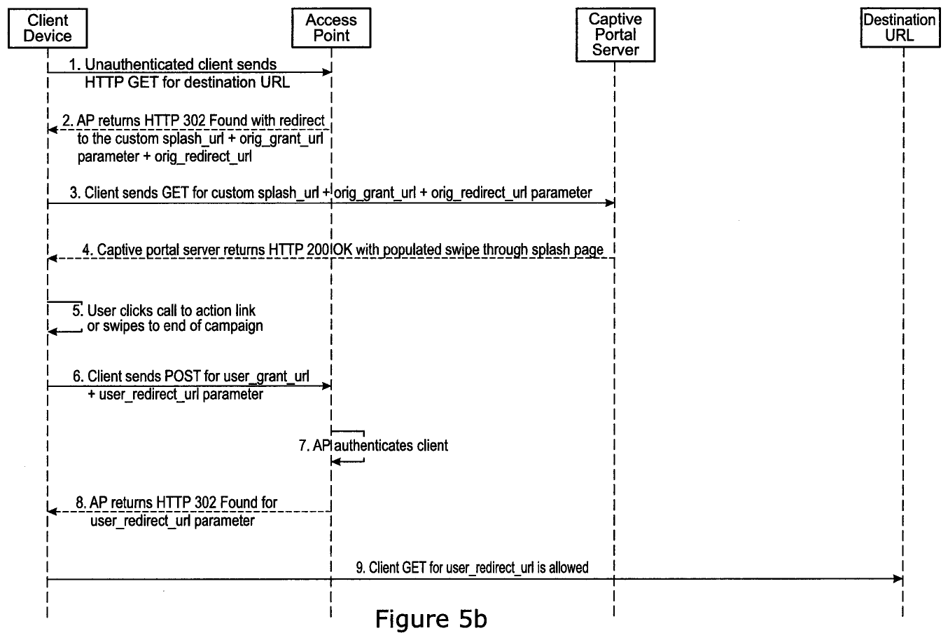

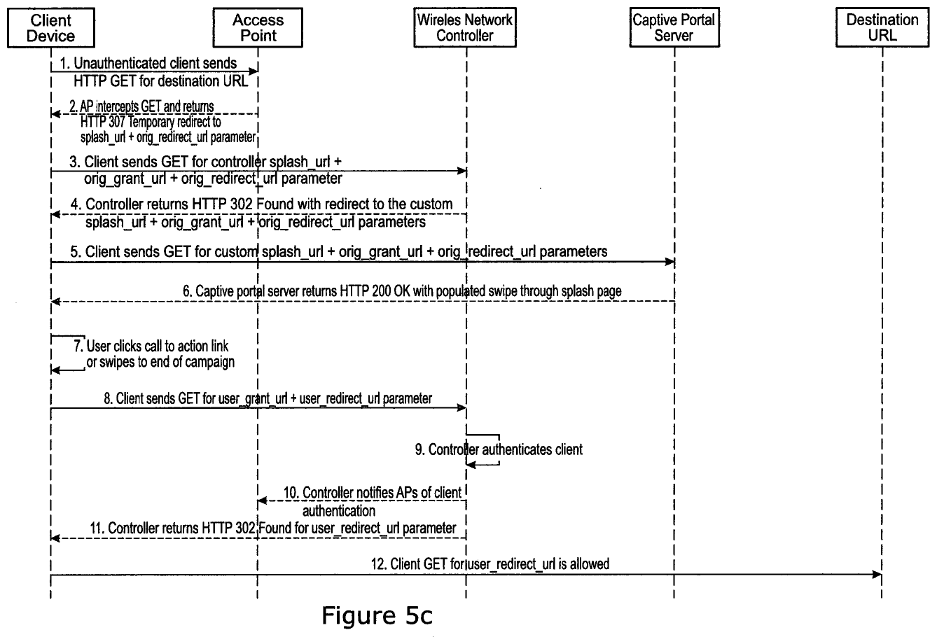

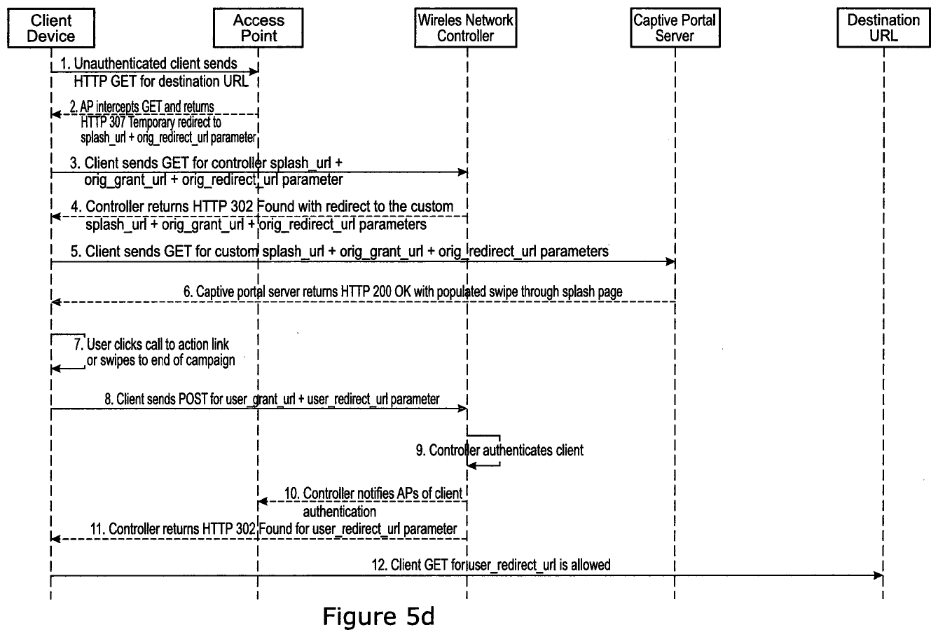

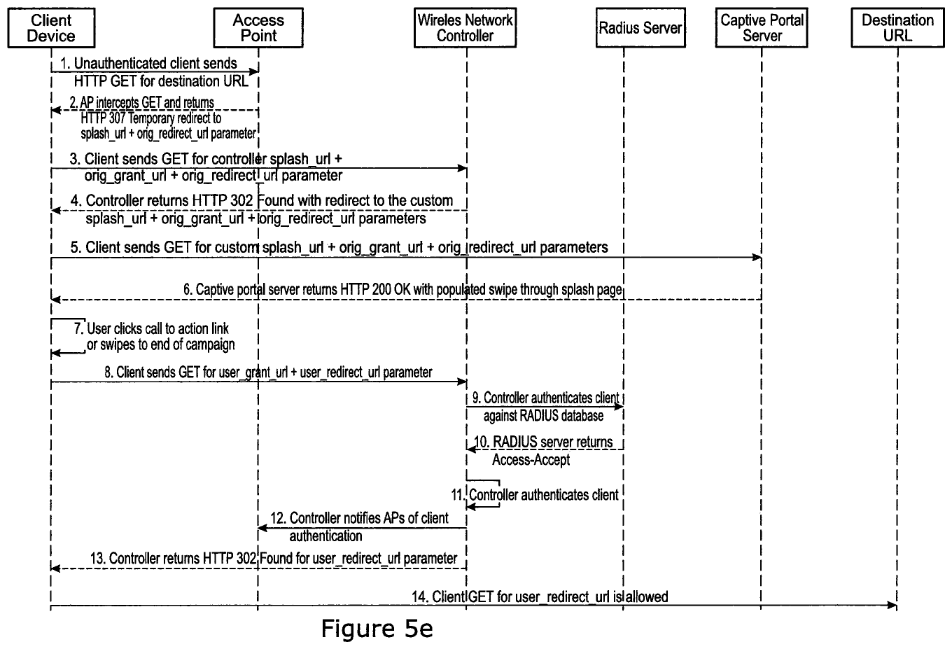

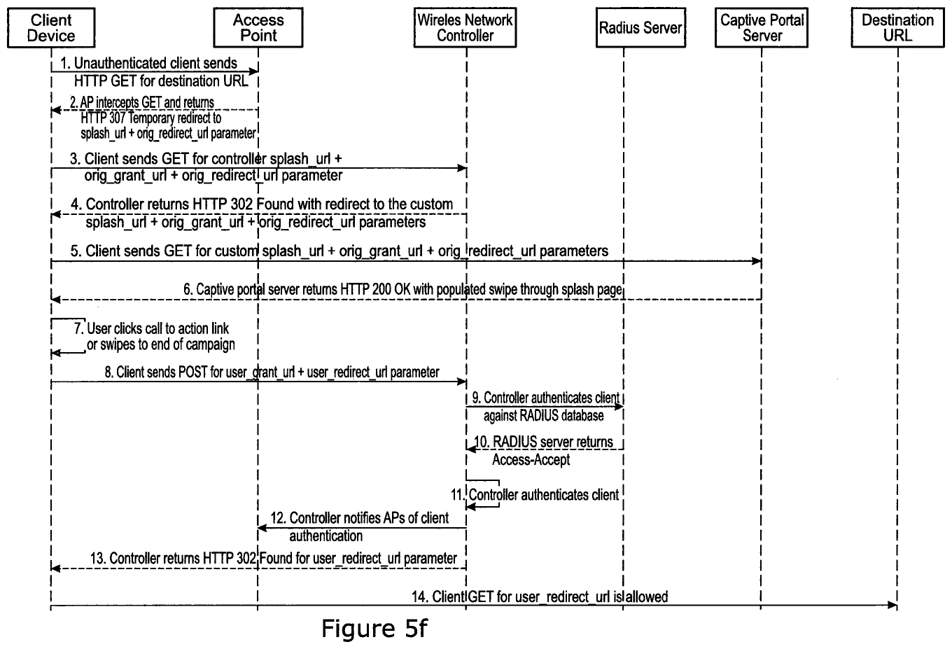

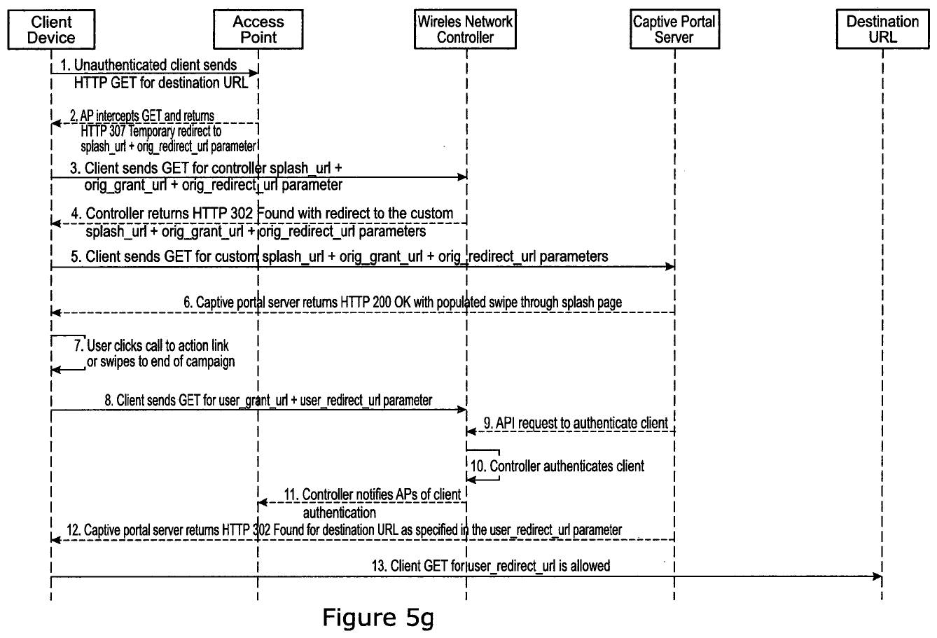

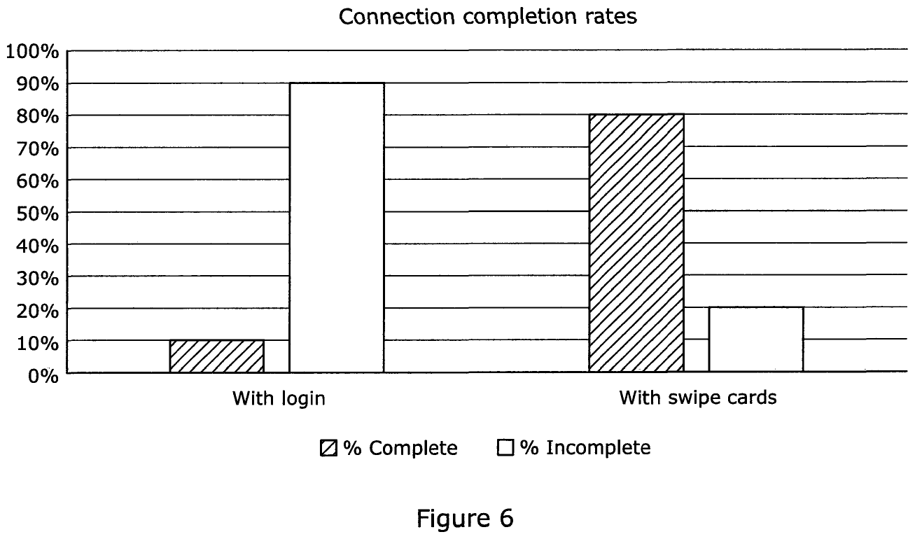

FIGS. 5a through 5g shows various examples of the processes for unauthenticated clients (devices) accessing the internet using the present invention with a number of common parameters defined as follows.

| Parameter | Function |
|---|---|
| splash_url | URL client is directed to begin |
| | splash authentication process. |
| orig_grant_url | Tells the captive portal server which |
| | value to use for the grant URL. |
| orig_redirect_url | Tells the captive portal server which |
| | value to use for the redirection after |
| | authentication. |
| user_grant_url | Click-through splash page authentication URL. |
| user_redirect_url | URL client should be redirected to after |
| | interaction with a card or end of campaign that |
| | supersedes the orig_redirect_url. |
| node_mac | Access point MAC address. |
| | Used to look up active campaign. |
| client_mac | Client device MAC address. Used for campaign |
| | analytics. Client MAC |
| | addresses are hashed, salted and truncated |
| | before storing so they are not identifiable. |

FIG. 5a is a sequence diagram that shows an example of the interactions required to connect to a wireless network using HTTP GETs:

1. Unauthenticated client sends an HTTP GET request for a web page.

2. AP detects an HTTP GET request sent from the unauthenticated client, intercepts it and returns an HTTP 302 Redirect to the custom splash_url. The HTTP 302 Redirect URL also contains additional parameters such as the orig_grant_url, orig_redirect_url, node_mac and client_mac.

3. Client receives the redirect response and sends a GET request to the custom splash_url hosted on the captive portal server along with the additional parameters provided within the response (e.g. orig_grant_url, orig_redirect_url, node_mac, client_mac).

4. When the captive portal server receives the GET request for the custom splash_url, it looks up the active campaign associated with the access point based on the supplied node_mac parameter. It then builds a URL for each user interactable card in the campaign, as well as the campaign landing page URL, that contains the user_grant_url and user_redirect_url parameter. It then returns an HTTP 200 OK response along with the populated swipe-through splash page.

5. User clicks call to action button/link in a card or swipes to the end of campaign.

6. Client sends a GET for the user_grant_url along with the user_redirect_url parameter.

7. AP receives the request for the user_grant_url along with the user_redirect_url parameter and the client is then authenticated.

8. The AP then responds to the client with an HTTP 302 Found for the URL specified in the user_redirect_url parameter.

9. Because the client is no longer subject to Captive Portal as they are authenticated, they are now able to perform a GET request to the URL specified in the user_redirect_url parameter successfully.

FIG. 5b is a sequence diagram which shows an example of the interactions required to connect to a wireless network using HTTP POSTs:

1. Unauthenticated client sends an HTTP GET request for a web page.

2. AP detects an HTTP GET request sent from the unauthenticated client, intercepts it and returns an HTTP 302 Redirect to the custom splash_url. The HTTP 302 Redirect URL also contains additional parameters such as the orig_grant_url, orig_redirect_url, node_mac and client_mac.

3. Client receives the redirect response and sends a GET request to the custom splash_url hosted on the captive portal server along with the additional parameters provided within the response (e.g. orig_grant_url, orig_redirect_url, node_mac, client_mac).

4. When the captive portal server receives the GET request for the custom splash_url, it looks up the active campaign associated with the access point based on the supplied node_mac parameter. It then builds a URL for each user interactable card in the campaign, as well as the campaign landing page URL, that contains the user_grant_url and user_redirect_url parameter. It then returns an HTTP 200 OK response along with the populated swipe-through splash page.

5. User clicks call to action button/link in a card or swipes to the end of campaign.

6. Client sends a POST for the user_grant_url along with the user_redirect_url parameter.

7. AP receives the request for the user_grant_url along with the user_redirect_url parameter and the client is then authenticated.

8. The AP then responds to the client with an HTTP 302 Found for the URL specified in the user_redirect_url parameter.

9. Because the client is no longer subject to Captive Portal as they are authenticated, they are now able to perform a GET request to the URL specified in the user_redirect_url parameter successfully.

FIG. 5c is a sequence diagram which shows an example of the interactions required to connect to a wireless network managed by a wireless network controller using HTTP GETs:

1. Unauthenticated client sends an HTTP GET request for a web page.

2. AP detects an HTTP GET request sent from the unauthenticated client, intercepts it and returns an HTTP 307 Temporary Redirect to the splash_url. The HTTP 307 Temporary Redirect URL also contains additional parameters such as the orig_grant_url, orig_redirect_url, node_mac and client_mac. The splash_url refers to a page located on the controller.

3. Client receives redirect response from the AP and sends an HTTP GET to the wireless network controller for the splash_url. The splash_url contains a orig_redirect_url parameter used during the splash authentication session to inform the wireless network controller which website the client was originally trying to fetch prior to being redirected.

4. When the wireless network controller receives the GET request for the splash URL, it returns an HTTP 302 Found redirecting the client to the custom splash_url.

5. Client receives the response and sends a GET request for the custom splash_url hosted on the captive portal server which uses the request's orig_grant_url and the orig_redirect_url parameters to build the grant URLs for the splash page.

6. When the captive portal server receives the GET request for the custom splash_url, it looks up the active campaign associated with the access point based on the supplied node_mac parameter. It then builds a URL for each user interactable card in the campaign, as well as the campaign landing page URL, that contains the user_grant_url and user_redirect_url parameter. It then returns an HTTP 200 OK response along with the populated swipe-through splash page.

7. User clicks call to action button/link in a card or swipes to the end of campaign.

8. Client sends a GET for the user_grant_url along with the user_redirect_url parameter.

9. Controller receives the request for the user_grant_url along with the user_redirect_url parameter and the client is then authenticated.

10. The wireless network controller notifies all of the APs in the network of the client's authentication.

11. The controller then responds to the client with an HTTP 302 Found for the URL specified in the user_redirect_url parameter.

12. Because the client is no longer subject to Captive Portal as they are authenticated, they are now able to perform a GET request to the URL specified in the user_redirect_url parameter successfully.

FIG. 5d is a sequence diagram which shows an example of the interactions required to connect to a wireless network managed by a wireless network controller using HTTP POSTs:

1. Unauthenticated client sends an HTTP GET request for a web page.

2. AP detects an HTTP GET request sent from the unauthenticated client, intercepts it and returns an HTTP 307 Temporary Redirect to the splash_url. The HTTP 307 Temporary Redirect URL also contains additional parameters such as the orig_grant_url, orig_redirect_url, node_mac and client_mac. The splash_url refers to a page located on the controller.

3. Client receives redirect response from the AP and sends an HTTP GET to the wireless network controller for the splash_url. The splash_url contains a orig_redirect_url parameter used during the splash authentication session to inform the wireless network controller which website the client was originally trying to fetch prior to being redirected.

4. When the wireless network controller receives the GET request for the splash URL, it returns an HTTP 302 Found redirecting the client to the custom splash_url.

5. Client receives the response and sends a GET request for the custom splash_url hosted on the captive portal server which uses the request's orig_grant_url and the orig_redirect_url parameters to build the grant URLs for the splash page.

6. When the captive portal server receives the GET request for the custom splash_url, it looks up the active campaign associated with the access point based on the supplied node_mac parameter. It then builds a URL for each user interactable card in the campaign, as well as the campaign landing page URL, that contains the user_grant_url and user_redirect_url parameter. It then returns an HTTP 200 OK response along with the populated swipe-through splash page.

7. User clicks call to action button/link in a card or swipes to the end of campaign.

8. Client sends a POST for the user_grant_url along with the user_redirect_url parameter.

9. Controller receives the request for the user_grant_url along with the user_redirect_url parameter and the client is then authenticated.

10. The wireless network controller notifies all of the APs in the network of the client's authentication.

11. The controller then responds to the client with an HTTP 302 Found for the URL specified in the user_redirect_url parameter.

12. Because the client is no longer subject to Captive Portal as they are authenticated, they are now able to perform a GET request to the URL specified in the user_redirect_url parameter successfully.

FIG. 5e is a sequence diagram which shows an example of the interactions required to connect to a wireless network managed by a wireless network controller using HTTP GETs and RADIUS authentication:

1. Unauthenticated client sends an HTTP GET request for a web page.

2. AP detects an HTTP GET request sent from the unauthenticated client, intercepts it and returns an HTTP 307 Temporary Redirect to the splash_url. The HTTP 307 Temporary Redirect URL also contains additional parameters such as the orig_grant_url, orig_redirect_url, node_mac and client_mac. The splash_url refers to a page located on the controller.

3. Client receives redirect response from the AP and sends an HTTP GET to the wireless network controller for the splash_url. The splash_url contains a orig_redirect_url parameter used during the splash authentication session to inform the wireless network controller which website the client was originally trying to fetch prior to being redirected.

4. When the wireless network controller receives the GET request for the splash URL, it returns an HTTP 302 Found redirecting the client to the custom splash_url.

5. Client receives the response and sends a GET request for the custom splash_url hosted on the captive portal server which uses the request's orig_grant_url and the orig_redirect_url parameters to build the grant URLs for the splash page.

6. When the captive portal server receives the GET request for the custom splash_url, it looks up the active campaign associated with the access point based on the supplied node_mac parameter. It then builds a URL for each user interactable card in the campaign, as well as the campaign landing page URL, that contains the user_grant_url and user_redirect_url parameter. It then returns an HTTP 200 OK response along with the populated swipe-through splash page.

7. User clicks call to action button/link in a card or swipes to the end of campaign.

8. Client sends a GET for the user_grant_url along with the user_redirect_url parameter.

9. Controller receives the request for the user_grant_url along with the user_redirect_url parameter and makes an external authentication attempt against a RADIUS server using predefined credentials.

10. RADIUS server returns Access-Accept response to the external wireless network controller.

11. The wireless network controller authenticates the captive portal.

12. The wireless network controller notifies all of the APs in the network of the client's authentication.

13. The controller then responds to the client with an HTTP 302 Found for the URL specified in the user_redirect_url parameter.

14. Because the client is no longer subject to Captive Portal as they are authenticated, they are now able to perform a GET request to the URL specified in the user_redirect_url parameter successfully.

FIG. 5f is a sequence diagram which shows an example of the interactions required to connect to a wireless network managed by a wireless network controller using HTTP POSTs and RADIUS authentication:

1. Unauthenticated client sends an HTTP GET request for a web page.

2. AP detects an HTTP GET request sent from the unauthenticated client, intercepts it and returns an HTTP 307 Temporary Redirect to the splash_url. The HTTP 307 Temporary Redirect URL also contains additional parameters such as the orig_grant_url, orig_redirect_url, node_mac and client_mac. The splash_url refers to a page located on the controller.

3. Client receives redirect response from the AP and sends an HTTP GET to the wireless network controller for the splash_url. The splash_url contains a orig_redirect_url parameter used during the splash authentication session to inform the wireless network controller which website the client was originally trying to fetch prior to being redirected.

4. When the wireless network controller receives the GET request for the splash URL, it returns an HTTP 302 Found redirecting the client to the custom splash_url.

5. Client receives the response and sends a GET request for the custom splash_url hosted on the captive portal server which uses the request's orig_grant_url and the orig_redirect_url parameters to build the grant URLs for the splash page.

6. When the captive portal server receives the GET request for the custom splash_url, it looks up the active campaign associated with the access point based on the supplied node_mac parameter. It then builds a URL for each user interactable card in the campaign, as well as the campaign landing page URL, that contains the user_grant_url and user_redirect_url parameter. It then returns an HTTP 200 OK response along with the populated swipe-through splash page.

7. User clicks call to action button/link in a card or swipes to the end of campaign.

8. Client sends a POST for the user_grant_url along with the user_redirect_url parameter.

9. Controller receives the request for the user_grant_url along with the user_redirect_url parameter and makes an external authentication attempt against a RADIUS server using predefined credentials.

10. RADIUS server returns Access-Accept response to the external wireless network controller.

11. The wireless network controller authenticates the captive portal.

12. The wireless network controller notifies all of the APs in the network of the client's authentication.

13. The controller then responds to the client with an HTTP 302 Found for the URL specified in the user_redirect_url parameter.

14. Because the client is no longer subject to Captive Portal as they are authenticated, they are now able to perform a GET request to the URL specified in the user_redirect_url parameter successfully.

FIG. 5g is a sequence diagram which shows an example of the interactions required to connect to a wireless network managed by a wireless network controller using API requests:

1. Unauthenticated client sends an HTTP GET request for a web page.

2. AP detects an HTTP GET request sent from the unauthenticated client, intercepts it and returns an HTTP 307 Temporary Redirect to the splash_url. The HTTP 307 Temporary Redirect URL also contains additional parameters such as the orig_grant_url, orig_redirect_url, node_mac and client_mac. The splash_url refers to a page located on the controller.

3. Client receives redirect response from the AP and sends an HTTP GET to the wireless network controller for the splash_url. The splash_url contains a orig_redirect_url parameter used during the splash authentication session to inform the wireless network controller which website the client was originally trying to fetch prior to being redirected.

4. When the wireless network controller receives the GET request for the splash URL, it returns an HTTP 302 Found redirecting the client to the custom splash_url.

5. Client receives the response and sends a GET request for the custom splash_url hosted on the captive portal server which uses the request's orig_grant_url and the orig_redirect_url parameters to build the grant URLs for the splash page.

6. When the captive portal server receives the GET request for the custom splash_url, it looks up the active campaign associated with the access point based on the supplied node_mac parameter. It then builds a URL for each user interactable card in the campaign, as well as the campaign landing page URL, that contains the user_grant_url and user_redirect_url parameter. It then returns an HTTP 200 OK response along with the populated swipe-through splash page.

7. User clicks call to action button/link in a card or swipes to the end of campaign.

8. Client sends a HTTP GET to the user_grant_url along with the user_redirect_url parameter.

9. The captive portal server receives the request for the user_grant_url along with the user_redirect_url parameter and makes an external authentication attempt wireless network controller using predefined credentials.

10. The wireless network controller authenticates the captive portal.

11. The wireless network controller notifies all of the APs in the network of the client's authentication.

12. The external captive portal then responds to the client with an HTTP 302 Found for the URL specified in the user_redirect_url parameter.

13. Because the client is no longer subject to Captive Portal as they are authenticated, they are now able to perform a GET request to the URL specified in the user_redirect_url parameter successfully.

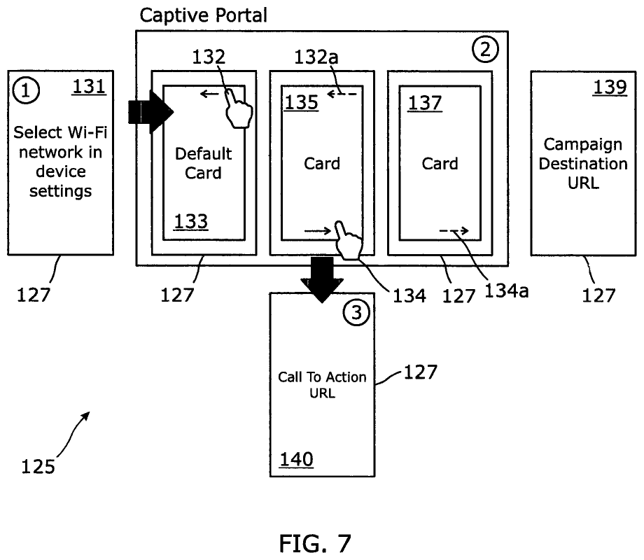

FIG. 7 is a schematic diagram which illustrates a swipe to connect process in accordance with the present invention. In particular it shows the use of first and second gestures to allow the user to access information in sequence and/or access more detailed content on a website, prior to being provided with internet access. It will be appreciated that this embodiment will also allow a user to gain internet access without selecting a call to action URL.

At the first step 131, the user accesses the settings on the device, identifies and requests connection with the vendor network. Once connection has been established the device 1 receives upon its graphical user interface a first vendor defined content page, the default card 133, at this point the user will view the content of the page 133 and decide whether it is of interest. If it is not of interest the user can swipe 132 through the content using a second gesture which in this embodiment of the invention is a swipe across the screen from right to left as denoted by the solid line arrow. Once the user has swiped 132, the second content page 135 is shown. In this case, the user has decided that the content is of interest and uses a first gesture, which in this example is a swipe across the screen from left to right 134 on the graphical user interface to access additional information on the contents of page 140.

Card 135 also shows the option of swiping right to left, denoted by dashed arrow 132a, as an alternative to swiping left to right 134. Had that option been taken, content on card 137 would have been shown and the user would have had the option of selecting that content using left to right gesture 134a. Full internet access 139 is granted after either of these actions has been selected.

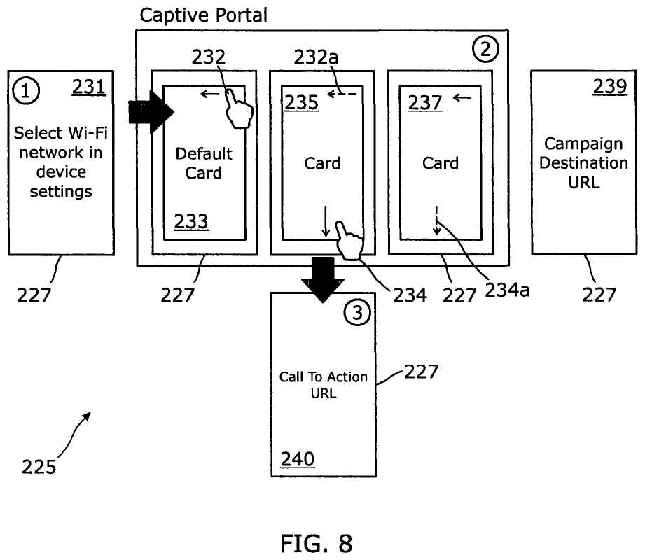

FIG. 8 is a schematic diagram which illustrates a swipe to connect process in accordance with the present invention. In particular it shows the use of first and second gestures to allow the user to access information in sequence and/or access more detailed content on a website, prior to being provided with internet access. It will be appreciated that this embodiment will also allow a user to gain internet access without selecting a call to action URL.

At the first step 231, the user accesses the settings on the device, identifies and requests connection with the vendor network. Once connection has been established the device receives upon its graphical user interface a first vendor defined content page, the default card 233, at this point the user will view the content of the page 233 and decide whether it is of interest. If it is not of interest the user can swipe 232 through the content using a second gesture which, in this embodiment of the invention is a swipe across the screen from right to left as denoted by the solid line arrow. Once the user has swiped 232, the second content page 235 is shown. In this case, the user has decided that the content is of interest and uses a first gesture, which in this example is a swipe downwards 234 on the graphical user interface to access additional information on the contents of page 240.

Card 235 also shows the option of swiping right to left, denoted by dashed arrow 232a, as an alternative to swiping downwards 234. Had that option been taken, content on card 237 would have been shown and the user would have had the option of selecting that content using downward gesture 234a. Full internet access 239 is granted after either of these actions has been selected.

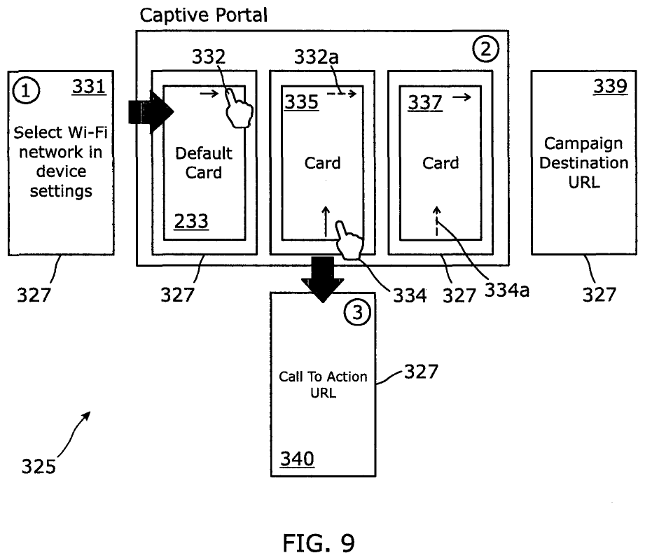

FIG. 9 is a schematic diagram which illustrates a swipe to connect process in accordance with the present invention. In particular it shows the use of first and second gestures to allow the user to access information in sequence and/or access more detailed content on a website, prior to being provided with internet access. It will be appreciated that this embodiment will also allow a user to gain internet access without selecting a call to action URL.

At the first step 331, the user accesses the settings on the device, identifies and requests connection with the vendor network. Once connection has been established the device receives upon its graphical user interface a first vendor defined content page, the default card 333, at this point the user will view the content of the page 333 and decide whether it is of interest. If it is not of interest the user can swipe 332 through the content using a second gesture which, in this embodiment of the invention is a swipe across the screen from left to right as denoted by the solid line arrow. Once the user has swiped 332, the second content page 335 is shown. In this case, the user has decided that the content is of interest and uses a first gesture, which in this example is a swipe upwards 334 on the graphical user interface to access additional information on the contents of page 340.

Card 335 also shows the option of swiping right to left, denoted by dashed arrow 332a, as an alternative to swiping downwards 334. Had that option been taken, content on card 337 would have been shown and the user would have had the option of selecting that content using downward gesture 334a or swiping left to right. Full internet access 339 is granted after either of these actions has been selected.

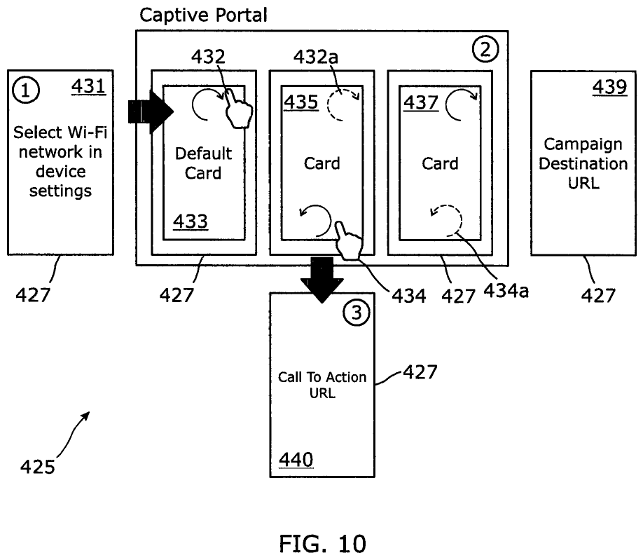

FIG. 10 is a schematic diagram which illustrates a swipe to connect process in accordance with the present invention. In particular it shows the use of first and second gestures to allow the user to access information in sequence and/or access more detailed content on a website, prior to being provided with Internet access. It will be appreciated that this embodiment will also allow a user to gain internet access without selecting a call to action URL.

At the first step 431, the user requests connection with the vendor network. Once connection has been established the device receives upon its graphical user interface a first vendor defined content page, the default card 433, at this point the user will view the content of the page 433 and decide whether it is of interest. If it is not of interest the user can swipe 432 through the content using a second gesture which, in this embodiment of the invention is a clockwise circular or arcuate movement 432 across the screen as denoted by the solid line arrow. Once the user has swiped 432, the second content page 435 is shown. In this case, the user has decided that the content is of interest and uses a first gesture, which in this example is n anti-clockwise circular or arcuate movement 432 across the screen 434 on the graphical user interface to access additional information on the contents of page 440.

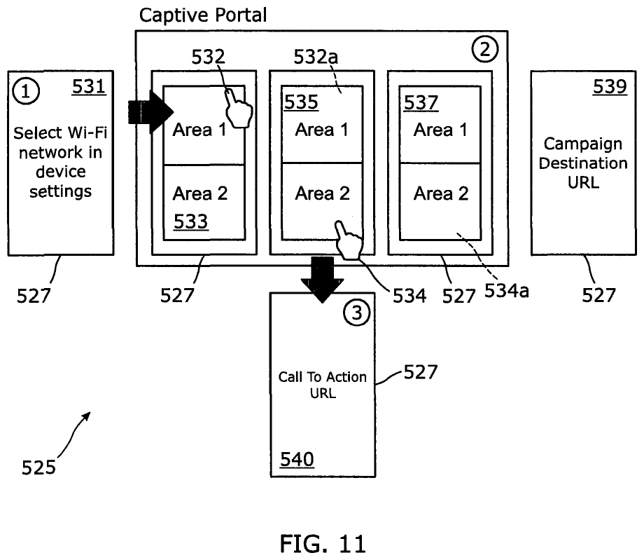

Card 435 also shows the option of swiping clockwise, denoted by dashed arrow 432a, as an alternative to swiping anticlockwise 434. Had that option been taken, content on card 437 would have been shown and the user would have had the option of selecting that content using anticlockwise gesture 434a or using a clockwise gesture. Full internet access 339 is granted after either of these actions has been selected. FIG. 11 is a schematic diagram which illustrates a swipe to connect process in accordance with the present invention. In particular it shows the use of first and second gestures to allow the user to access information in sequence and/or access more detailed content on a website, prior to being provided with Internet access. It will be appreciated that this embodiment will also allow a user to gain internet access without selecting a call to action URL.

At the first step 531, the user requests connection with the vendor network. Once connection has been established the device receives upon its graphical user interface a first vendor defined content page, the default card 533, at this point the user will view the content of the page 533 and decide whether it is of interest. If it is not of interest the user can swipe 532 through the content using a second gesture which, in this embodiment of the invention is as any gesture in the area shown as area 1. Once the user has gestured 532, the second content page 535 is shown. In this case, the user has decided that the content is of interest and uses a second gesture, which in this example is any gesture 534 in area 2 to access additional information on the contents of page 540.

Card 535 also shows the option selecting area 1. Had area 1 been selected, content on card 537 would have been shown and the user would have had the option of selecting that content using a gesture on area 2 or selecting area 1. Full internet access 539 is granted after either of these actions has been selected.

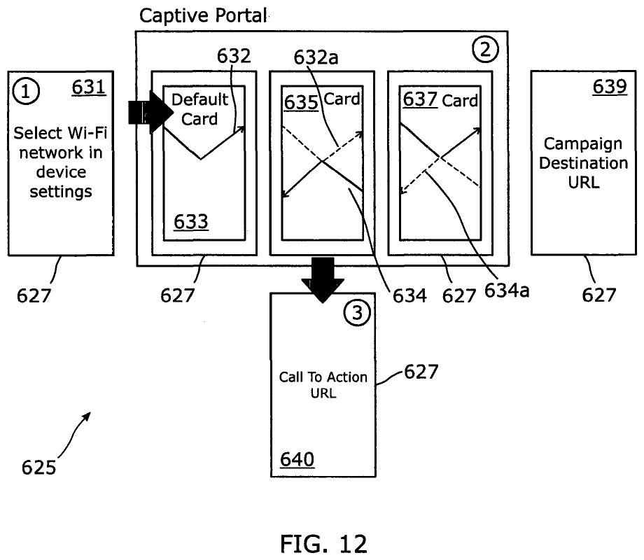

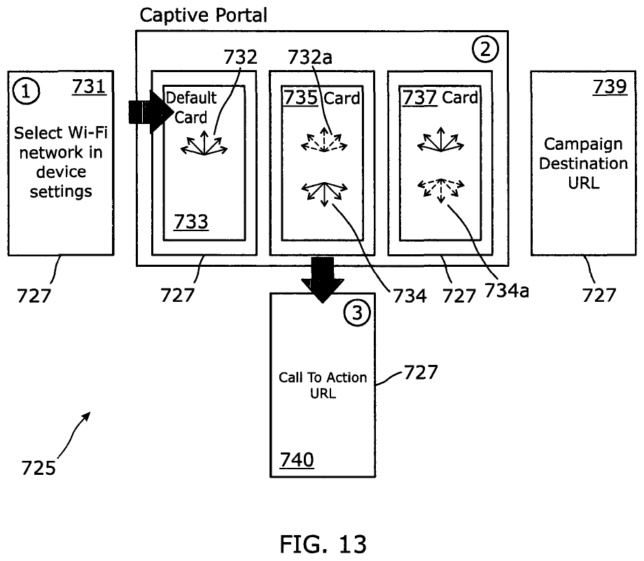

FIG. 12 is a schematic diagram which illustrates a swipe to connect process in accordance with the present invention. In particular it shows the use of first and second gestures to allow the user to access information in sequence and/or access more detailed content on a website, prior to being provided with internet access. It will be appreciated that this embodiment will also allow a user to gain Internet access without selecting a call to action URL.

At the first step 631, the user requests connection with the vendor network. Once connection has been established the device receives upon its graphical user interface a first vendor defined content page, the default card 633, at this point the user will view the content of the page 633 and decide whether it is of interest. If it is not of interest the user can swipe 632 through the content using a second gesture 632 which, in this embodiment of the invention is any gesture which occurs in a first space on the graphical user interface defined by a first arc subtended by a predetermined angle as defined with reference to a reference line across the graphical user interface.

Once the user has gestured 632, the second content page 635 is shown. In this case, the user has decided that the content is of interest and uses a first gesture 634, which in this example is any gesture in a second space on the graphical user interface defined by a second arc subtended by a predetermined angle as defined with reference to the reference line such that the first space and the second space are on opposing sides of the reference line. The gesture 634 on the graphical user interface provides to access additional information on the contents of page 640.

Card 635 also shows the option of using the second gesture denoted by dashed line segment 632a, as an alternative to using the first gesture. Had that option been taken, content on card 637 would have been shown and the user would have had the option of selecting that content using first gesture 634a or using a second gesture. Full internet access 339 is granted after either of these actions has been selected.

The first and second spaces may be conjoined or separate on the graphical user interface and the angle subtended in each case may be up to 180°. It may be advantageous to either separate the first and second spaces by making the angle less than 180°, such as 150° or 140°. The spaces may be spaced apart along the major or minor axis of the graphical user interface.

Optionally, the predetermined angle is between 45 and 135° with respect the reference line.

FIG. 14 is a schematic diagram which illustrates a swipe to connect process in accordance with the present invention. In particular it shows the use of first and second gestures to allow the user to access information in sequence and/or access more detailed content on a website, prior to being provided with internet access. It will be appreciated that this embodiment will also allow a user to gain internet access without selecting a call to action URL.

At the first step 731, the user requests connection with the vendor network. Once connection has been established the device receives upon its graphical user interface a first vendor defined content page, the default card 733, at this point the user will view the content of the page 733 and decide whether it is of interest. If it is not of interest the user can swipe 732 through the content using a second gesture which, in this embodiment of the invention is any of a plurality of linear swipes extending upwards on the screen. Once the user has swiped 732, the second content page 735 is shown.

In this case, the user has decided that the content is of interest and uses a first gesture, which in this example is any of a plurality of linear swipes extending downwards on the screen 732 to access additional information on the contents of page 440.

Card 735 also shows the option of the second gesture 732a, as an alternative to accessing content using gesture 734. Had that option been taken, content on card 737 would have been shown and the user would have had the option of selecting that content using gesture 734a. Full internet access 339 is granted after either of these actions has been selected.

In order to assist, the following explanations of terminology used and general exemplification of the process of using the invention are offered.

A captive portal is a web page accessed with a web browser that is displayed to newly connected users of a Wi-Fi network before they are granted broader access to network resources. Captive portals are commonly used to present a landing or log-in page which may require authentication, payment, acceptance of an end-user license agreement or an acceptable use policy, or other valid credentials that both the host and user agree to adhere by.

A splash page (also known as a captive portal) can provide a customized branding experience to wireless users in addition to prompting for username/password credentials. This is the web page used to display a campaign containing content cards that the user must see before completing the authentication process.

An organisation profile resides on the content management system and can hold many campaigns and content cards.

Campaigns have a default completion action (i.e. redirection URL upon successful authentication) and can contain one or more content cards.

Content cards are created and assigned to campaigns in the content management system. The content displayed in cards need not be dictated to by the card type. Card types include simple image, image with call to action button (e.g. visit shop) and blog but extensibility of the content management system allows for the development of additional card types supporting more complex interactions (e.g. Facebook® likes, TripAdvisor® rating, newsletter signup and other third-party API integrations). Versions of the content management system will support WYSIWYG card creation allowing functionality to be added to a single card type from a library of available functionality.

Default card is first card presented to unauthenticated devices connecting to the wireless network. Custom branding/messaging or authentication requirements (such as username/password or surname/room number) can be applied to this card as required.

A vendor network operator is the person or group responsible for the configuration of the wireless hardware at the venue or premises. This is almost always also the creator of the campaign and the associated content cards. The content management system is a cloud-based web application that allows a vendor network operator to create content cards and campaigns.

A user connects to a wireless network that has been configured to utilise captive portal functionality with the splash page setting pointing to the content management system. Based on the MAC address of the wireless access point or gateway device that a user is connecting from (or a network or location ID or such like), a campaign is selected to be displayed to the user.

The default card is the first card presented to the unauthenticated device connecting to the wireless network. The format and content of the default card can be of two types:

(i) Custom branding and messaging, or

(ii) Custom branding and messaging with required authentication

Both types can have custom branding and messaging as defined by the campaign creator. Type (ii) also includes required authentication functionality. This can be in the form of various combinations of user submitted information based on the vendor network operators' requirements (e.g. username and password, room number and surname, access code, etc.). Third-party APIs are then used to validate the user submitted information, and upon successful validation the user is automatically presented with the first content card. If validation fails, the user is asked to re-enter the required authentication credentials.

In summary,

1. User connects to wireless network by selecting network's SSID on their device

2. User then:

a. swipes through the default card, or

b. authenticates through the default card.

3. User then:

a. clicks on a call to action link or blog link in any content card in the campaign, or

b. swipes to the end of the campaign in the captive portal.

4. Device is authenticated onto wireless network and then:

a. redirected to call to action or blog card destination URL, or

b. redirected to the campaign completion URL.

The content management system is used to by vendor network operators to upload content that can be used to create content cards and campaigns. The content management system is a cloud-based web application. All content cards and campaigns reside on the content management system not on a user's device or vendor network operators network device.

The content management system is also used to display the campaign and content cards to the user in the form of a splash page. Users are presented with the default card as well as additional content cards that can be interacted with using multiple gestures. After interacting with the content cards the user is authenticated on to the wireless network and will be redirected to the relevant action URL. Alternatively, they can continue to swipe to the end of the content cards to authenticate on to the wireless network and be redirected to the campaign completion URL.

The content cards displayed to the user are primarily determined based on what content cards the vendor network operator has assigned to the campaign. The determination of what campaign to display to the user is based on the MAC address of the wireless access point or gateway device that the user is connecting from or via a network or location Id or such like.

Additional content cards may be dynamically added to the campaign to promote third-party services or products. The vendor network operator has the option of opting-out from dynamically displaying third-party promotions. When, opted-in, the vendor network operator can select specific categories of promotions allowed/disallowed, as well as maintaining blacklists of unwanted vendors, products or services from being displayed to the user.

A user may interact with a content card using several gestures such as:

(i) a click,

(ii) a tap,

(iii) a double tap,

(iv) a press,

(v) a pinch,

(vi) a spread, or

(vii) a swipe.

Typically, a click will be made by a user's finger, or by using a hand-held pointing device such as a computer mouse or track pad. The pointing action will be a short pointing press against the graphical user made by a user's finger a stylus, pointer or the like. Typically, a swipe will be made by a user's finger, or by using a hand-held pointing device such as a computer mouse or track pad. The swipe comprises a prolonged movement across the graphical user interface made by a user's finger a stylus, pointer or the like.

A swipe gesture may comprise of a prolonged movement across the graphic user interface in a variety of directions:

(i) left to right,

(ii) right to left,

(iii) down to up,

(iv) up to down, or

(v) any angular variation of the above where the beginning and end of the swipe are

completed in a somewhat linear fashion.

A user may interact with a content card using several in-air gestures that can be summarily described as:

(i) an in-air scroll, or

(ii) an in-air swipe.

Typically, an in-air scroll will be made by a user's hand or finger. The in-air scroll comprises a prolonged movement across the graphical user interface in a vertical fashion. Typically, an in-air swipe will be made by a user's hand or finger. The in-air swipe comprises a prolonged movement across the graphical user interface in a horizontal fashion.

A user may interact with a content card using several physical gestures that can be summarily described as:

(i) a shake,

(ii) a rotation, or

(iii) a bump.

Typically, a rotation will be made by a user and involve tilting the device left or right on the sagittal plane up to a 45-degree angle and measured using a devices built-in inclinometer. Typically, a bump will be made by a user and involve causing the device to strike another object with enough force to as not be described as a touch and be measured using a devices built-in accelerometer. This may involve a device being struck against the palm of a hand. Eyeball tracking/head tracking

The present invention provides targeted content to devices in which the vendor (wilt network owner) can schedule campaigns, create bespoke campaigns, give vendor engagement opportunities.

The location of wi-fi access point can be determined, such as via the MAC address to publish campaigns to specific areas. This could be used to target content at, for example fans of opposing football teams.

Campaign could include public information which may encourage user trust and network usage.

The present invention provides:
Improved customer engagement;
Builds customer loyalty and drive increased repeat visit frequency, visit duration;
customer spend, social media followers, etc.;
more merchandising and promotion opportunities;
Increased awareness and uptake of new offerings, special offers, etc.;
Allows the promotion of special events;
Advertising opportunities;
The opportunity to sell space on content cards to suppliers, advertisers, etc. Public information
Culture, entertainment, transport information in Smart City deployments Customer behavioural analytics
Understand customer behaviours to inform marketing and sales strategies and tactics

It also provides:
hyperlocal content which advertises to the right person, right place, right time;
Content management under control of the operator;
Highly actionable analytics insights; and
Is extensible via integrations including social and IoT (Internet of Things) feeds.

Improvements and modifications may be incorporated herein without deviating from the scope of the invention.

1. A computer implemented content management system for providing content to a device based upon the location of the device:
wherein the content management system stores a VNO profile, campaigns and content cards which are displayable on a screen of a device;
such that, upon receiving a connection request from the device via a vendor network, a captive portal is displayed on the device populated with content from the content management system wherein:
(iv) A user:
a. gestures to progress beyond a default card from the screen, or
b. submits data progress beyond the default card (pre-authentication)
(v) the device is authenticated onto the vendor network and then redirected to a campaign completion URL network if no additional content available, if additional content is available, the device is shown n additional content cards displayed sequentially upon detection of a second and subsequent gesture until,
(vi) User:
a. gestures on a call to action link in a content card in the campaign, wherein device is authenticated onto vendor network and then redirected to call to action destination URL, or
b. gestures to progress through the remaining content cards, after which, device is authenticated onto vendor network and then redirected to the campaign completion URL.

2. A computer implemented graphical control element for a device, the control element comprising a captive portal for a device, being adapted to display the captive portal which is presented to the device from a content management system via a vendor network, wherein, the captive portal displays at least one content card on the screen of the device wherein:
(iv) A user:
a. gestures to progress beyond a default card from the screen, or
b. submits data progress beyond the default card (pre-authentication)
(v) the device is authenticated onto the vendor network and then redirected to a campaign completion URL network if no additional content available, if additional content is available, the device is shown n additional content cards displayed sequentially upon detection of a second and subsequent gesture until,
(vi) User:
a. gestures on a call to action link in a content card in the campaign, wherein device is authenticated onto vendor network and then redirected to call to action destination URL, or
b. gestures to progress through the remaining content cards, after which, device is authenticated onto vendor network and then redirected to the campaign completion URL.

3. A computer implemented content management system for providing content to a device based upon the location of the device:
wherein the content management system stores a vendor profile and zero or more content cards contained in a captive portal and which are displayable on a screen of the device;
such that, upon receiving a connection request from the device via a vendor network, the captive portal is provided to the device from the content management system via a vendor network, the captive portal displaying the content to the device wherein;
(i) A user:
a. gestures to progress beyond a default card from the screen, or
b. submits data progress beyond the default card (pre-authentication)
(ii) the device is authenticated onto the vendor network and then redirected to
a campaign completion URL network if no additional content available, if additional content is available, the device is shown n additional content cards displayed sequentially upon detection of a second and subsequent gesture until,
(iii) User:
a. gestures on a call to action link in a content card in the campaign, wherein device is authenticated onto vendor network and then redirected to call to action destination URL, or
b. gestures to progress through the remaining content cards, after which, device is authenticated onto vendor network and then redirected to the campaign completion URL.

4. A system as claimed in claim 1 wherein, the content management system is a cloud hosted web application.

5. A system as claimed in claim 1 wherein, one default card is present in the campaign.

6. A system as claimed in claim 1 wherein, at least one content card is present in a campaign but not required.

7. A system as claimed in claim 1 wherein, the n additional content cards in a campaign are displayed sequentially where n=>0.

8. A system as claimed in claim 1 wherein, the vendor network comprises one or more wireless access points.

9. A system as claimed in claim 1 wherein, the vendor network includes a wireless controller.

10. A system as claimed in claim 9 wherein, the wireless controller is a cloud-based software application.

11. A system as claimed in claim 1 wherein, a content management system is provided to allow the vendor to manage the content.

12. A system as claimed in claim 1 wherein, the content management system comprises a graphical user interface.

13. A system as claimed in claim 1 wherein the content management system also provides an API (Application Programming Interface)

14. A system as claimed in claim 13 wherein, the API allows vendor defined content to be uploaded to the content management system.

15. A system as claimed in claim 1 wherein, the content management system can allow content to be mapped to one or more specified wireless access points.

16. A system as claimed in claim 13 wherein, the content management system can allow content to be mapped to one or more specified wireless access points based upon different criteria including time, date and location.

17. A system as claimed in claim 1 wherein, the content management system comprises at least one of the following features: user login, registration and management, content card and campaign management, access point management, billing and analytics dashboard.

18. A system as claimed in claim 1 wherein, one of the MAC address of the wireless access point, the network ID or location ID is used to determine its location.

19. (canceled)

20. A system as claimed in claim 1 wherein, where there is a plurality of wireless access points grouped for the purpose of receiving selectively uploaded vendor defined content and are grouped by their proximity to one another or by their proximity to goods or services.

21. (canceled)

22. (canceled)

23. A system as claimed in claim 1 wherein, the content management system can be configured to determine the order in which the content cards are presented to the device.

24. A system as claimed in claim 1 wherein, the content management system determines the content cards to be shown to the device based upon the device's location.

25. A system as claimed in claim 1 wherein, the graphical user interface has a touch screen.

26. A computer implemented content management system as claimed in claim 1 wherein, a first user gesture comprises at least one of: a swipe or a click or a pointing action on the graphical user interface of the device.

27. (canceled)

28. A computer implemented content management system as claimed in claim 1 wherein, the first user gesture comprising of a click will submit data entered by the user to confirm progress beyond the default card is allowed.

29. A computer implemented content management system as claimed in claim 1 wherein, the data entered by the user to confirm progress allowed beyond the default card is hotel room number and surname, access code or mobile phone number/SMS verification code.

30. A computer implemented content management system as claimed in claim 29 wherein, when a mobile phone number is entered to confirm progress is allowed beyond the default card, a verification code is sent via SMS to user's device.

31. A computer implemented content management system as claimed in claim 27 wherein, the click will be made using a hand held pointing device such as a computer mouse or track pad.

32. A computer implemented content management system as claimed in claim 31 wherein the pointing action will be a short pointing press against the graphical user made by a user's finger a stylus, pointer or the like.

33. A computer implemented content management system as claimed in claim 1, wherein, the second user gesture comprises moving a DOM element on the screen

34. A computer implemented content management system as claimed in claim 33 wherein, the second user gesture comprises a swipe on the graphical user interface of the device which comprises a prolonged movement across the graphical user interface.

35. A computer implemented content management system as claimed in claim 34 wherein, the prolonged movement may be made using a hand held pointing device such as a computer mouse or track pad.

36. A computer implemented content management system as claimed in claim 35 wherein, the prolonged movement may be made by a user's finger, a stylus, pointer or the like.

37. A computer implemented content management system as claimed in claim 1 wherein, the captive portal is displayed if the device is not authenticated when connecting to a vendor network.

38. A computer implemented content management system as claimed in claim 1, wherein the device is one of: a mobile phone, smart phone, tablet computer or laptop computer.

39. A computer implemented content management system as claimed in claim 1, wherein the system further comprises a tool that acquires and analyses data on the effectiveness of the campaigns and content cards.
